(19) United States
(12) Patent Application Publication
(10) Pub. No.: US 2026/0067425 A1
(43) Pub. Date: Mar. 5, 2026

(54) VIDEO PROCESSING METHOD AND SYSTEM

(71) Applicant: Nimagna AG, Zürich (CH)

(72) Inventors: Christoph Niederberger, Zürich (CH); Stephan Würmlin Stadler, Zürich (CH)

(21) Appl. No.: 18/875,836

(22) PCT Filed: Jun. 28, 2023
(86) PCT No.: PCT/EP2023/067568

§ 371 Date: Dec. 17, 2024

(30) Foreign Application Priority Data
Jun. 29, 2022 (CH) CH000784/2022

(51) Int. Cl. H04N 7/15; G06T 3/40; G06T 7/194; G06T 7/70; G06V 40/16; G06V 40/20; H04N 5/272

(52) U.S. Cl. CPC H04N 7/157; G06T 3/40; G06T 7/194; G06T 7/70; G06V 40/174; G06V 40/28; H04N 5/272; G06T 2207/30244

(57) ABSTRACT

A computer implemented method for processing at least one video feed including images of a human presenter includes acquiring a first source video feed; extracting a first presenter video feed showing a human presenter; modifying the first presenter video feed; retrieving or generating background images video feeds; and compositing the modified first presenter video feed and background images or video feeds, thereby creating an output video feed. Modifying the first presenter video feed includes detecting, at least in the first source video feed, a trigger situation; and, depending on the trigger situation detected, modifying the first presenter video feed.

### BACKGROUND OF THE INVENTION

### Field of the Invention

The invention relates to the field of digital communication, and more particularly to relates to a video processing method and system.

### Description of Related Art

With the increasing use of videoconferencing, it becomes necessary to combine video streams of persons presenting information (“presenters”) with static images and/or recorded videos. Existing videoconferencing solutions combine such visual information from different sources by presenting it to viewers in separate sub-windows, and by allowing viewers to either not display some of the sub-windows all or only at a very small scale, in order to leave sufficient screen space for a single sub-window. Presenters must control the user interface of the videoconferencing system in order to choose and change the images or videos to be shown.

U.S. Pat. No. 11,223,798 B1 describes transmitting, in a networked video conference, a video image over a video channel. A content image is transmitted between attendees over a network channel that is separate from the video channel, rather than embedding it in the video image of, e.g., a host user. In an embodiment, images from two user's cameras are used as the video image and the content, respectively. At a destination device, the video and content signals are combined and displayed. User input at the destination device is used to determine display parameters of the video and content signals. In an embodiment, the content signal forms a background image at the second device. Portrait segmentation can be performed on a video image to isolate a first user's image.

U.S. Pat. No. 11,265,181 B1 discloses generating a composite video for a number of video feeds associated with users in a video session. A media background is generated for each video feed and can be used to present materials such as presentation slides. One or more presenters can then be seen on video during the session. A composite video can be generated by replacing a background behind a user by the media background. An annotation layer overlaid on top of the user's image allows for a presenter to produce live written annotations in conjunction with their own video presentations. In the background (prior art) section of U.S. Pat. No. 11,265,181 B1, manual or automatic switching between a camera trained on an instructor's face and another one showing a whiteboard is mentioned.

### SUMMARY OF THE INVENTION

It is therefore an object of the invention to create a method for processing at least one video feed, the video feed including images of a human presenter of the type mentioned initially, which overcomes the disadvantages mentioned above.

These objects are achieved by a method for processing at least one video feed, the video feed including images of a human presenter.

The computer implemented method for processing at least one video feed, the video feed including images of a human presenter, includes the steps of:
acquiring, with one or more audio-visual input devices, of a first User Equipment at least a first source video feed;
segmenting the first source video feed, thereby extracting a first presenter video feed showing a human presenter;
modifying the first presenter video feed, thereby creating a modified first presenter video feed;
retrieving or generating one or more background images or background video feeds;
compositing the modified first presenter video feed and the one or more background images or background video feeds, thereby creating an output video feed;
outputting the output video feed, in particular as a synthetic camera feed to a videoconferencing system;
wherein the step of modifying the first presenter video feed includes:
detecting, at least in the first source video feed, a trigger situation;
depending on the trigger situation detected, modifying the first presenter video feed.

The present invention makes it possible to create a presentation appearing as a TV production in a highly automatic manner. In particular, the selection, manipulation and compositing of camera shots can be fully automated. A minimal user interaction can remain, e.g., for the presenter to trigger a transition to a next phase in a sequence of predefined scenes. The resulting output video feed can be fed to the videoconferencing system without any changes to or special interaction with the videoconferencing system. Typically, this can be done by defining, on the presenter's personal computing device, a synthetic video camera that provides the output video feed. This synthetic camera is selected as the camera to be used by the client of the videoconferencing system that runs on the presenter's personal computing device. As a result, the output video feed appears to the videoconferencing system as conventional user video feed. This allows use of the present method and system with virtually any existing videoconferencing system.

The present invention also makes it possible to prepare information represented by the background images or background video feeds locally and in advance, without involving the videoconferencing system. This information can be integrated in real time with the presentation, without the need to adapt to requirements of different videoconferencing system interfaces, e.g. for sharing documents or for screen sharing. The presenter can prepare a presentation without regard to which videoconferencing system will be used.

By detecting trigger situations and modifying at least the presenter video feed, an engaging video feed can be created automatically, without the need for a human director to manipulate the video feed(s).

Furthermore, by modifying at least the presenter video feed, the output video feed can change, over time, the relative size of image regions used to represent, in the output video feed, the presenter on the one hand and information contained in the background images or background video feeds on the other hand. This makes it possible, over time, to show both the presenter and the background information at a reasonable size and resolution. This is in contrast to existing videoconferencing solutions, in which during a presentation the video feed with the presenter is made very small, or suppressed entirely, or needs a second screen in order to be displayed.

In embodiments, the step of segmenting the first source video feed and the step of modifying the first presenter video feed are performed as separate steps in this order. However, they can also be performed, with the same final result (the modified first presenter video feed), in another order. For example, modification steps such as scaling, up sampling, cropping, color-correcting etc. can be performed before or after segmentation. Performing them after segmentation, that is, only on the image region including the presenter, can reduce the computational load, since less pixels are affected.

The User Equipment typically is a personal computing device such as a personal computer, laptop, smartphone or the like, and includes at least a video camera and a microphone. These can be internal or external to the device. The User Equipment can include an additional video camera and/or a microphone, e.g. in a webcam.

A video feed is understood to include a sequence of images. A video feed can include an associated sound track. When reference is made to the segmentation of a video feed, this means the segmentation of the images constituting the video feed. Compositing refers to the process of layering multiple on-screen elements such as video, still images, text or graphical elements into a single video feed. When reference is made to compositing of a video feed with a background image or background video feed, this means the compositing of the images constituting the video feed with images constituting the background video feed, or with the background image, as the case may be. The step of compositing can also include the projecting of on-screen elements in a virtual 3D-scene. In other words, it can include arranging one or more of background images, background video feeds and presenter video feeds in a virtual 3D environment and rendering this environment as seen by a virtual camera.

In embodiments, the step of detecting trigger situations includes detecting a video trigger situation in a video feed, typically in a source video feed or in a presenter video feed,
in particular wherein the video trigger situation is at least one of:
   recognition of a hand gesture performed by the presenter;
   a change of the degree in which the presenter's movements are animated;
   a facial expression of the presenter;
   the head of the presenter turning;
   the presenter moving as a whole.

In embodiments, the step of detecting trigger situations includes detecting a sound trigger situation in at least one sound track, typically in a sound track of the source video feed or presenter video feed,
in particular wherein the sound trigger situation is at least one of:
   recognition of a keyword or key phrase in the presenter's speech;
   an increase or decrease in average loudness of the presenter's speech;
   a pause in the presenter's speech.

The sound track typically is a sound track of an available video feed, typically of a source video feed or a presenter video feed.

The detection of video and sound trigger situations, summarily denoted “trigger situations”, allows to automatically initiate modification of the first presenter video feed, and/or of other video feeds or still images that are composited with the modified first presenter video feed. Such modifications are thereby temporally coordinated with the video feed. They can be implemented without the need for a human director.

In embodiments, modifying the first presenter video feed is also performed depending on an elapsed time since the last modification, for example when a time limit is exceeded. This results in variation in the output video feed even if no trigger situations have been detected.

In embodiments, the step of retrieving or generating the background image or background video feed includes retrieving them from a storybook dataset including an ordered sequence of background images and/or background video feeds.

In embodiments, a step of switching from a current background image or background video feed to a subsequent background image or background video feed in the sequence is triggered by an action by a user, in particular the presenter, and in particular by detection of a trigger situation.

The storybook dataset can be considered to define a set of predefined scenes. In the simplest case, the dataset includes a sequence of slides of a presentation. Each slide corresponds to a scene. Advancing through the sequence can be triggered by user input to the User Equipment, such as the presenter or another person hitting a key or clicking a mouse button. In embodiments, the advance is triggered by detection of a trigger situation, for example the user saying “next slide”, corresponding to a sound trigger situation, or the user performing a swiping motion with her hands, corresponding to a video trigger situation by recognition of a gesture.

In embodiments, the storybook includes other media, such as prerecorded video or audio feeds, and/or definitions of virtual 3D scenes. Each such medium or 3D scene corresponds to a scene of the storybook, and advancing through the sequence can be triggered as described above. In embodiments, the storybook defines a nonlinear combination of scenes, and a user interface is configured for the presenter to select a next scene and to trigger a transition to the selected next scene.

In embodiments, the storybook dataset includes at least one definition of a virtual 3D scene, and wherein at least one background image or background video feed is generated by rendering the virtual 3D scene in a virtual camera.

In embodiments, the step of compositing includes placing further background images or background video feeds in the virtual 3D environment and rendering them as part of the virtual 3D scene in the virtual camera.

In embodiments, the step of compositing includes placing the modified first presenter video feed in the virtual 3D environment and rendering it as part of the virtual 3D scene in the virtual camera.

In embodiments, the definition of the virtual 3D scene includes a definition of one or more foreground virtual objects and one or more background virtual objects, and the steps of rendering and/or compositing include arranging the modified first presenter video feed to appear in front of the one or more background virtual objects and behind the one or more foreground virtual objects. This allows to create the illusion of the presenter being present in the 3D scene with the virtual objects. The background virtual objects typically represent walls or projection surfaces. The foreground virtual objects typically represent a table, desk, lectern or the like.

In embodiments, the definition of the virtual 3D scene includes a definition of one or more background virtual objects, such as virtual walls or projection surfaces, and the steps of rendering and/or compositing include rendering or projecting a retrieved background video feed or retrieved background image on such a virtual wall or projection surface.

In embodiments, the step of modifying the first presenter video feed includes at least one of:
gradually zooming in onto the presenter's face, or gradually zooming away;
rapid switching to a view with different zoom level;
upscaling or downscaling;
rendering a virtual view of the presenter from a perspective other than that provided by physically existing video cameras;
modifying a soundtrack that is incorporated in the output video feed.

In embodiments, where there no physical zoom lens is present and controllable by the User Equipment, the zoom functions are implemented by digital zooming. Such zooming typically involves cropping parts of the zoomed image that come to lie outside the boundaries of the output video feed.

Rendering a virtual view of the presenter can include 3D reconstruction of the presenter's head and upper body and/or, if the User Equipment includes more than one camera, blending of multiple views of the presenter.

In embodiments, the step of modifying includes colour correction, in particular for harmonising the colour appearance of multiple cameras.

The soundtrack that is incorporated in the output video feed can be a source soundtrack of the first source video feed, a second source video feed or a further source video feed, or of a video feed derived from a source video feed. This depends on how the data flow in the User Equipment is set up.

In embodiments, modifying a soundtrack includes one or more of increasing or decreasing its volume, and modifying its acoustic characteristics, in particular reverb characteristics. This typically is done in a coordinated fashion with modification of the presenter video feed. For example, zooming in on the presenter can be synchronized with a slight increase of volume and/or a reverb parameter that is correlated with distance. In embodiments in which a virtual 3D scene is rendered, the soundtrack, in particular its reverb characteristic, is modified in accordance with changes in the relative location of the presenter, the virtual camera used and optionally also virtual objects in the 3D scene.

In embodiments, the steps recited are performed by the first User Equipment, in particular wherein the first User Equipment is a personal computing device such as a personal computer, laptop, smartphone or the like.

This makes it possible to implement the method locally, using only a presenter's User Equipment. There is no need to change or adapt the operation of software or systems operated by the videoconferencing system or other users. The method implemented on the User Equipment constitutes a standalone system for capturing audiovisual input and outputting the output video feed.

In embodiments, the method includes:
acquiring, with the first User Equipment a second source video feed;
segmenting the second source video feed, thereby extracting a second presenter video feed showing the human presenter;
modifying the second presenter video feed, thereby creating a modified second presenter video feed;
selectively compositing the modified second presenter video feed instead of the modified first presenter video feed when creating the output video feed, in particular depending on a detected trigger situation.

The statements regarding processing of the first source video feed apply to the second source video feed as well. The second source video feed can be acquired by a second camera that is part of the second User Equipment, e.g., a webcam linked to the personal computing device. The two cameras typically are arranged to observe the presenter from different points of view, thus providing different viewing angles of the presenter's upper or entire body. Selectively compositing the modified second presenter video feed instead of the modified first presenter video feed means switching between the first and second presenter video feed when compositing the final video feed. Video trigger situations associated with such switching typically can be the presenter's face turning to one of the cameras, or the presenter moving towards one of the cameras, and this automatically causing a switch to the video feed origination from this camera.

In embodiments, the step of compositing includes, when switching between the modified first and second presenter video feed, adapting the background image or background video feed according to a relative pose of a first camera and a second camera that generate the first source video feed and second source video feed, respectively; and/or wherein the method includes a camera registration step for determining the relative pose on the basis of the first source video feed and the second source video feed.

In embodiments, the background image or background video feed are created by rendering the virtual 3D scene by a first virtual camera and a second virtual camera, with a relative pose (position and orientation) of the two virtual cameras being made to be the same as the relative pose of the first camera and the second camera. Switching between the video feeds originating from the first and second camera (real camera feeds) is coordinated with switching between video feeds from the first and second virtual camera (virtual camera feeds). This makes the changes in perspective consistent for the real and virtual video feeds as they are composited to form the output video feed.

In embodiments, the method includes the steps of:
acquiring, with one or more audio-visual input devices of a second User Equipment at least a further source video feed;
segmenting the further source video feed, thereby extracting a further presenter video feed showing a human presenter;
modifying the further presenter video feed, thereby creating a modified further presenter video feed;
creating the output video feed by compositing the modified further presenter video feed in addition to the modified first presenter video feed and the background image or background video feed;
   in particular wherein the step of compositing includes placing the modified first presenter video feed and the modified further presenter video feed in the same virtual 3D environment.

In embodiments, the method includes performing the step of compositing in a processing unit, the processing unit being implemented in the first User Equipment, or the processing unit being implemented by a remote, cloud-based service.

In an embodiment in which the processing unit is implemented in the first User Equipment, a video feed originating from the second User Equipment (that is, the further source video feed or further presenter video feed) can be transmitted to the first user equipment through a network channel other than the output video feed. In particular, whereas the output video feed typically can be used as input to an arbitrary existing generic videoconferencing system, the video feed originating from the second User Equipment is transmitted to the first User Equipment by a channel that is separate from the generic videoconferencing system.

In an embodiment in which the processing unit is implemented by a remote, cloud-based service, video feeds originating from the first User Equipment and from the second User Equipment can be transmitted to the cloud-based service by channels that are separate from the generic videoconferencing system. The output video feed can be used as input to the existing generic videoconferencing system

In embodiments, when source videos from at least two different cameras are processed, the method includes the step of automatically adapting brightness and/or color of video feeds originating from these cameras.

The two different cameras can be part of the same UE, that is, cameras acquiring the first and second source video feed showing the same presenter. Alternatively or in addition, the two different cameras can be cameras from separate UEs, that is, cameras acquiring video feeds showing different presenters, typically wherein the presenters are geographically separated.

The computer program loadable into an internal memory of a personal computing device including a camera, microphone and an input device, the computer program including computer program code to make, when the computer program is loaded in the personal computing device, the personal computing device execute the method described herein.

The inventive method can be implemented as a method of operating a data-processing system. The invention can also be embodied in one or more of the following forms:
A data-processing apparatus or system including means for carrying out the method. Typically, the data-processing apparatus or system is programmed to carry out the method.
A computer program, or computer program product, adapted to perform the method. A computer program, typically including software code, adapted to perform the method. The computer program typically is loadable into an internal memory of a data processing system or apparatus, and includes computer-executable instructions to cause one or more processors of the data processing system or apparatus to execute the method.
The computer program can be carried on an electric carrier signal. In other words, the computer program is embodied as a reproducible computer-readable signal, and thus can be transmitted in the form of such a signal.
A computer-readable storage medium or data carrier including the program. The computer readable medium is non-transitory; that is, tangible.

### BRIEF DESCRIPTION OF THE DRAWINGS

The subject matter of the invention will be explained in more detail in the following text with reference to exemplary embodiments which are illustrated in the attached drawings, which schematically show:

FIG. 1 a system for video conferencing;

FIG. 2 a structure of a first User Equipment;

FIG. 3 a flow of information according to the method for processing video feed;

FIG. 4 a communication structure for implementing the method with two presenters;

FIG. 5 an alterative communication structure with two presenters.

### DETAILED DESCRIPTION OF THE INVENTION

In principle, identical or functionally identical parts are provided with the same reference symbols in the figures.

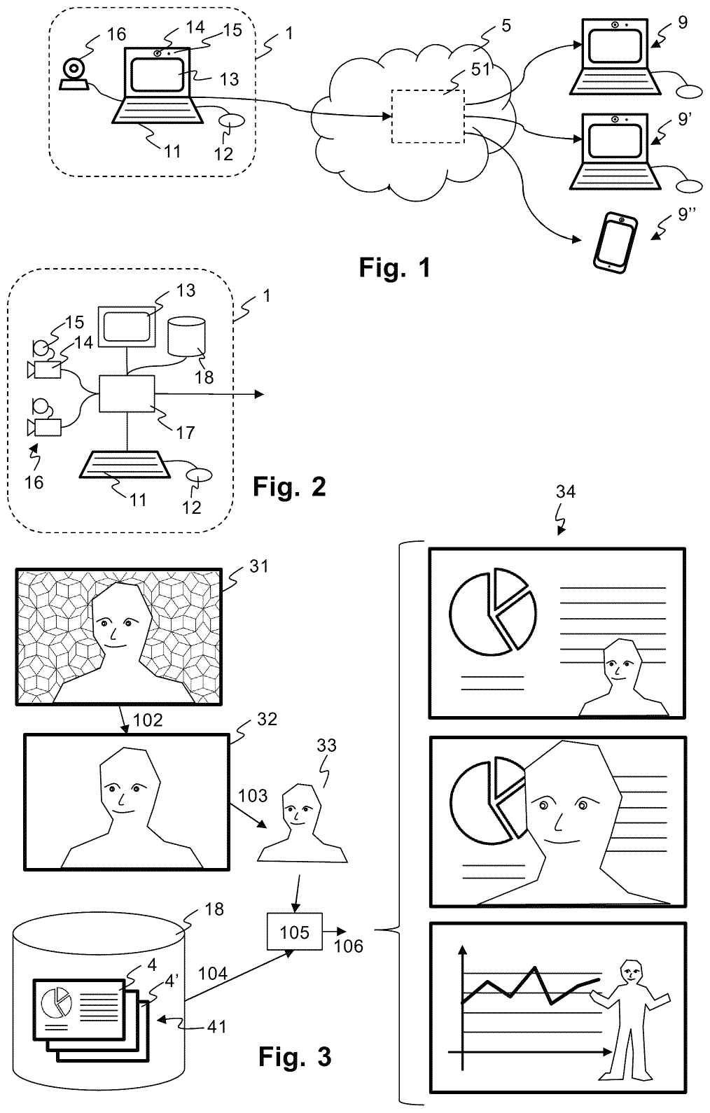

FIG. 1 shows a system for video conferencing. Therein, a first User Equipment 1 and further participant devices 9, 9′, 9″ are connected through a wide area network 5, typically the internet. The first User Equipment 1 and further devices shall summarily be called user devices. The user devices include personal computing devices such as desktop computers, laptop computers or smartphones and the like. They each include audio-visual input devices such as a camera 14 and microphone 15 as well as audio-visual output devices such as a screen 13 and speaker. They are functionally connected by a videoconferencing system 51 operated by a provider of videoconferencing services.

Commonly known examples of such videoconferencing systems 51 are Zoom™, Skype™, WebEx™, Starleaf™, Microsoft Teams™ etc. The videoconferencing system 51 interacts with client software running on the user devices, which captures a video feed from the audio-visual input devices and displays a video feed received from the videoconferencing system 51. Generally, this can happen simultaneously, and so each user can see the other users and be seen by the other users. In certain settings, called “one-to-many” or “few-to-many”, one or more users take the role of presenters, and the other users are in the role of participants in a virtual lecture. FIG. 1 represents this by arrows on the lines, corresponding to network connections, linking the user devices 1, 9, 9′, 9″ to the videoconferencing system 51: the arrows represent the main flow of content from one presenter to multiple participants, though, on the technical level, the flow of audio-visual information can be in both directions.

The presenter's user device shall be called first User Equipment 1 in the context of the present document. It appears to the videoconferencing system 51 no different than the other user devices 9, 9′, 9″, and typically is a generic personal computing device, optionally connected to an additional audio-visual input device such as a webcam 16.

FIG. 2 shows a structure of a first User Equipment 1, with, in addition to the elements already described, further elements used in the remainder of the present description: the camera 14, microphone 15 and an optional webcam 16 provide audio-visual input in the form of a video feed to a processing unit 17. The processing unit 17 is connected to a data storage unit 18 for storing and retrieving digital data, a screen 13 and speaker for outputting audio-visual information, and further input devices such as a keyboard 11 and mouse 12, or a touchscreen (not shown). In other embodiments, further input webcams 16 or other input devices are present.

In line with the present invention, at least one of the user devices, called first User Equipment 1, is programmed to process a video feed captured by its audio-visual input devices 14, 15, 16 and to feed the processed video feed to the videoconferencing system 51 instead of the captured video feed. The videoconferencing system 51 is agnostic to the fact that this processing takes place. The videoconferencing system 51 need not be adapted to or interfaced in a special way with the software implementing the present invention.

FIG. 3 shows a flow of information according to the present method for processing a video feed. Therein, a first source video feed 31 is combined with further images or videos 4, 4′ to form an output video feed 34 that is transmitted to the videoconferencing system 51. The processing includes the following steps.

In a segmenting step 102, typically performed by a segmentation software unit running on the processing unit 17, a first source video feed 31 captured by the input devices is segmented to extract the part of the video feed, that is, of the images constituting the video feed, the presenter. The result is a first presenter video feed 32. Segmentation algorithms for extracting a speaker (“portrait segmentation”) or, conversely, for background removal, are generally known, and are used in existing videoconferencing clients.

In a modifying step 103, typically performed by a modification software unit running on the processing unit 17, the first presenter video feed 32 is modified, creating a modified first presenter video feed 33. The modification can include, for example:
gradually zooming in onto the presenter's face, or gradually zooming away;
rapid switching to a view with different zoom level;
upscaling or downscaling;
rendering a virtual view of the presenter from a perspective other than that provided by physically existing video cameras;
modifying a soundtrack that is incorporated in the output video feed.

In a retrieving or generating step 104, typically performed by a retrieval or generation software unit running on the processing unit 17, still images or video clips to be used as background image 4 or background video feed 4′ are retrieved from a storybook dataset 41 stored in the data storage unit 18. The storybook dataset 41 defines a sequence of still images (like slides in a conventional presentation) and/or video feeds. The background image 4 or background video feed 4′ shall summarily be referred to as background media. In embodiments, a background medium (still image or video) is generated by rendering a virtual 3D scene, defined in the storybook dataset 41, in a virtual camera.

In a compositing step 105, typically performed by a compositing software unit running on the processing unit 17, the background media and the modified first presenter video feed 33 are composited, resulting in the output video feed 34. This can include rendering a background video or image on a virtual projection surface in the virtual 3D scene. The modified first presenter video feed 33 can be composited to appear in front of the rendered virtual 3D scene. Alternatively, the modified first presenter video feed 33 can also be projected on a virtual projection surface or billboard in the virtual 3D scene. Optionally, a virtual foreground object (which from the point of view of the information flow is part of the background media), such as a table or lectern can be composited to appear in front of the presenter, or can also be part of and rendered with the virtual 3D scene.

In an outputting step 106, typically performed by an output software unit running on the processing unit 17, the output video feed 34 is output, typically to a local client of the videoconferencing system 51. In settings in which the videoconferencing system 51 provides a corresponding API, the output video feed 34 can be fed directly to the videoconferencing system 51.

The modifications applied to the first presenter video feed 32, the step of retrieving or generating 104 and the step of compositing 105 are controlled by a virtual director.

The three schematic frame to the right of FIG. 3 are examples for the operation of the virtual director, as it controls the appearance the output video feed 34:
In the top frame the modified first presenter video feed 33 is downscaled and inserted to the lower right of the frame, on top of a static slide serving as background image.
In the middle frame the modified first presenter video feed 33 is magnified and cropped, and covers a larger area of the same background image. A transition from the top to the middle frame can be a gradual zooming in on the presenter.
In the bottom frame, a full view of the presenter is shown on top of another static or animated slide serving as background. This assumes that the presenter has moved further away from the camera, or that a further camera is trained on the user, from another angle and/or distance. Alternatively, it can be the case that in the preceding frames the presenter was shown at a high zoom or magnification level, and the zoom or magnification level has been reduced so as to show the full view of the presenter.

Such zooming/magnification, cropping and placement of the presenter relative to the background can be triggered by audible and/or visual cues extracted from one of the video feeds such as the first source video feed 31 or the first presenter video feed 32, or a video feed of another camera. Other triggers can be a command originating from the presenter to switch to a next background image 4 or background video feed 4′, which simultaneously or with a time delay triggers a modification of the presenter video feed. Another trigger can be simply that a particular view of the presenter has been active for a certain time.

Known technologies can be used to detect trigger situations. For example, determining differences between images or optical flow analysis can be used to determine a degree to which a presenter's movements are animated, that is, whether the presenter moves a lot or is more at rest. A facial expression of the presenter can be determined by facial expression analysis software. Keywords or trigger phrases can be determined by speech analysis. Gestures or head and body movements can be determined by video analysis.

In embodiments in which an additional input device 16 with a camera is present, acquiring a second source video feed, the director also controls the generation of a corresponding modified second presenter video feed. When generating the output video feed 34, the director can switch between the modified first and second presenter feeds. Switching between the feeds can be triggered by the detection of trigger situations. In particular, an appropriate trigger situation can be when the presenter looks into a camera that currently is not active. In this case, the switching is caused by the presenter.

When switching from one video feed to the other, the director can inform the user in advance, by means of information displayed on the screen 13, that it will execute the switch. In this case, the switching is caused by the director. The user is invited in advance to face the soon to be active camera.

In the context of two or more cameras, it can be useful to know a relative pose (position and orientation) of the first and second camera. This can be done with an automatic registration step, in which the two cameras observe the same object, such as the presenter's head, and from this determine their relative pose. Alternatively, by means of a user input, the presenter specifies an approximate relative position of an additional camera. Such an approximate relative position can be rudimentary in that it represents only the fact that the additional camera is to the left or to the right of the first camera (as seen by the user). It can be more specific in that it represents an approximate angle between the first camera 14 and the additional camera 16.

In embodiments, two presenters are active. So, in addition to the first User Equipment 1 there is a second User Equipment 2 with essentially the same internal structure. In each of these, the steps of segmenting 102 and modifying 103 the corresponding source video feed can be performed locally. However, the step of generating and outputting 106 the output video feed 34 is performed by a single instance, so that the output video feed 34 can be input to the videoconferencing system 51 without the need for adapting operation of the videoconferencing system 51. This typically requires the steps of retrieving or generating 104 the background and of compositing 105 to be performed by a single instance.

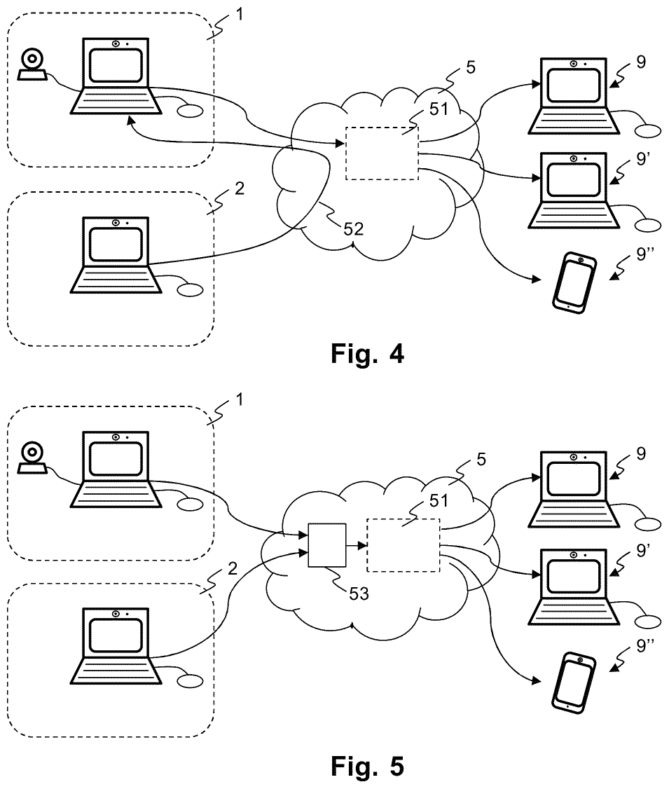

FIG. 4 shows a communication structure for implementing the method with two presenters. As in FIG. 1, the arrows represent a main flow of content, typically image data, whereas information for controlling and coordinating the flow of content can be exchanged in both directions. In the structure of FIG. 4, the single instance is the first User Equipment 1. It receives a video feed from the second User Equipment 2 through a separate network channel 52 that is not related to the videoconferencing system 51. This video feed can be a modified further presenter video feed showing the second presenter. This allows the computational load for modifying a further presenter video feed to be carried by the second User Equipment 2. Commands for controlling this modifying are sent from a director running on the first User Equipment 1 to the second User Equipment 2. Furthermore, the first User Equipment 1 can send further information to the second User Equipment 2. This further information can instruct the second User Equipment 2 whether to transmit its video feed or not. In situations in which the further video feed is not included in the final output, this reduces the communication load. The further information can include instructions or information that are displayed to the presenter at the second User Equipment 2. Such information can inform the presenter that her video feed is not active (that is, not included in the output video feed 34), or that it will be switched to be active or inactive in a certain number of seconds. Such instructions can instruct the presenter that she could act more lively or speak louder, or, in a setting with more than one camera, turn her head to look into a particular camera. The same kind of information and instructions can also be displayed to the presenter at the first User Equipment 1. The same kind of instructions can also be displayed to a presenter at a first User Equipment 1 when no second User Equipment 2 is present.

The second User Equipment 2 can send further metadata about the further video it is capturing (the further source video feed or the further presenter video feed) to the first User Equipment 1. Such further metadata represents trigger situations detected by the second User Equipment 2 in its video feed or feeds. This further metadata is used by the director running on the first User Equipment 1 to control the video processing in the first User Equipment 1 and to generate the commands sent to the second User Equipment 2.

FIG. 5 shows an alternative communication structure with two presenters. Herein, the single instance is a cloud-based service 53. The function of the cloud-based service 53 is analogous to that of the director in the first User Equipment 1 of FIG. 4: it receives on the one hand metadata, in particular about trigger situations detected, from both the first User Equipment 1 and second User Equipment 2. On the other hand, it receives a respective presenter video feed 32 or modified presenter video feed 33 from the first User Equipment 1 and the second User Equipment 2, respectively. It controls the first User Equipment 1 and second User Equipment 2, including the sending of these video feeds, by sending corresponding commands.

While the invention has been described in present embodiments, it is distinctly understood that the invention is not limited thereto, but may be otherwise variously embodied and practised within the scope of the claims.

1. A computer implemented method for processing at least one video feed, the video feed comprising images of a human presenter, the method comprising the steps of:
acquiring, with one or more audio-visual input devices, of a first User Equipment at least a first source video feed;
segmenting the first source video feed, thereby extracting a first presenter video feed showing a human presenter;
modifying the first presenter video feed, thereby creating a modified first presenter video feed;
retrieving or generating one or more background images or background video feeds;
compositing the modified first presenter video feed and the one or more background images or background video feeds, thereby creating an output video feed;
outputting the output video feed as a synthetic camera feed to a videoconferencing system;
wherein modifying the first presenter video feed comprises the steps of:
detecting, at least in the first source video feed, a trigger situation;
depending on the trigger situation detected, modifying the first presenter video feed.

2. The method of claim 1, wherein the step of detecting trigger situations comprises detecting a video trigger situation in a video feed, typically in a source video feed or in a presenter video feed,
wherein the video trigger situation is at least one of:
recognition of a hand gesture performed by the presenter;
a change of the degree in which the presenter's movements are animated;
a facial expression of the presenter;
the head of the presenter turning;
the presenter moving as a whole.

3. The method of claim 1, wherein the step of detecting trigger situations comprises detecting a sound trigger situation in at least one sound track, typically in a sound track of the source video feed or presenter video feed,
wherein the sound trigger situation is at least one of:
recognition of a keyword or key phrase in the presenter's speech;
an increase or decrease in average loudness of the presenter's speech;
a pause in the presenter's speech.

4. The method of claim 1, wherein the step of retrieving or generating the background image or background video feed comprises retrieving them from a storybook dataset comprising an ordered sequence of background images and/or background video feeds.

5. The method of claim 1, wherein a step of switching from a current background image or background video feed to a subsequent background image or background video feed in the sequence is triggered by detection of a trigger situation.

6. The method of claim 4, wherein the storybook dataset comprises at least one definition of a virtual 3D scene, and wherein at least one background image or background video feed is generated by rendering the virtual 3D scene in a virtual camera.

7. The method of claim 6, wherein the step of compositing comprises placing further background images or background video feeds in the virtual 3D environment and rendering them as part of the virtual 3D scene in the virtual camera.

8. The method of claim 6, wherein the step of compositing comprises placing the modified first presenter video feed in the virtual 3D environment and rendering it as part of the virtual 3D scene in the virtual camera.

9. The method of claim 1, wherein the step of modifying the first presenter video feed comprises at least one of:
gradually zooming in onto the presenter's face, or gradually zooming away;
rapid switching to a view with different zoom level;
upscaling or downscaling;
rendering a virtual view of the presenter from a perspective other than that provided by physically existing video cameras;
modifying a soundtrack that is incorporated in the output video feed.

10. The method of claim 1, wherein the steps recited are performed by the first User Equipment, and wherein the first User Equipment is a personal computing device.

11. The method of claim 1, further comprising the steps of:
acquiring, with the first User Equipment a second source video feed;
segmenting the second source video feed, thereby extracting a second presenter video feed showing the human presenter;
modifying the second presenter video feed, thereby creating a modified second presenter video feed
selectively compositing the modified second presenter video feed instead of the modified first presenter video feed when creating the output video feed depending on a detected trigger situation.

12. The method of claim 11, wherein the step of compositing comprises, when switching between the modified first and second presenter video feed, adapting the background image or background video feed according to a relative pose of a first camera and a second camera that generate the first source video feed and second source video feed, respectively;
and/or wherein the method comprises a camera registration step for determining the relative pose based upon the first source video feed and the second source video feed.

13. The method of claim 1, further comprising the steps of
acquiring, with one or more audio-visual input devices of a second User Equipment at least a further source video feed;
segmenting the further source video feed, thereby extracting a further presenter video feed showing a human presenter;
modifying the further presenter video feed, thereby creating a modified further presenter video feed
creating the output video feed by compositing the modified further presenter video feed in addition to the modified first presenter video feed and the background image or background video feed;
wherein the step of compositing comprises placing the modified first presenter video feed and the modified further presenter video feed in the same virtual 3D environment.

14. The method of claim 13, comprising performing the step compositing in a processing unit, the processing unit being implemented in the first User Equipment, or the processing unit being implemented by a remote, cloud-based service.

15. A computer program loadable into an internal memory of a personal computing device comprising a camera, microphone and an input device, the computer program comprising computer program code to make, when said computer program is loaded in the personal computing device, the personal computing device execute the method according to claim 1.
